(19) United States
(12) Patent Application Publication
(10) Pub. No.: US 2010/0282177 A1
(43) Pub. Date: Nov. 11, 2010

(54) BIODEGRADABLE ORGANIC MATERIALS CONTAINER AND SYSTEM INCORPORATING SAME

(75) Inventor: Germain Rivard, Ithaca, NY (US)

Correspondence Address: BOND, SCHOENECK & KING, PLLC, 10 BROWN ROAD, SUITE 201, ITHACA, NY, 14850-1248, US

(73) Assignee: MouseCare, Inc., Ithaca, NY (US)

(21) Appl. No.: 12/436,531

(22) Filed: May 6, 2009

(51) Int. Cl. A01K 1/02; A01K 1/03

(52) U.S. Cl. 119/417

(57) ABSTRACT

A biodegradable container (‘cage unit’) for organic materials includes a solid cage base having a floor and at least two opposing sides extending upwardly therefrom. The cage base is made from a non-petroleum-based material. An animal-resistant coating is bonded to at least a portion of the inside surfaces of the cage. A cage cover comprises filtered air entry and exit apertures and a non-ventilated top surface. A front portion of the top surface has a viewing window. A gas-adsorbent material is coupled to an interior surface of the non-windowed portion of the cover. A containment rack system comprises a vertical, columnar support structure to receive cage unit support members; one or more cage units; a columnar plenum having an open side area and an open top area and, optionally, a canopy having a fan and an exhaust port. When docked on the rack, the rear end of the cage is raised with respect to its front-end at an angle between about 5 to 20 degrees with respect to horizontal.

### CROSS-REFERENCE TO RELATED APPLICATIONS

N/A.

### BACKGROUND OF THE INVENTION

1. Field of the Invention

Embodiments of the instant invention pertain generally to biodegradable containers for organic materials including, but not limited to, live small animals, biological materials, plants, and the like. More particularly, embodiments of the invention are directed to an improved small-animal cage and an improved containment system incorporating one or more embodied small-animal cages.

2. Technical Background

U.S. Pat. No. 6,571,731 entitled Animal Caging And Biological Storage Systems, the subject matter of which is incorporated herein by reference in its entirety to the fullest allowable extent, describes a novel microisolation container for laboratory animals or other species. The background section of the '731 patent discloses that tens of millions of laboratory animals are used each year. Consequently, tens of millions of cages are also necessary to house these animals.

On a collective level, some of the overwhelming challenges presented by the occupancy of the aforementioned cages include controlling animal heat loads and odor. The cage described in the '731 patent relies, in part, on laminar convective air flow generated by animal heat to ventilate the microenvironment through filter membranes to eliminate the buildup of harmful gases and provide good air quality within the enclosure. Typically, fresh air enters the cage through an inlet vent in the lower portion of the front-side of the cage base, while spent air is passively output through an elevated, rear-side vent near or in the cage cover. The exhaust air can be actively evacuated by an auxiliary exhaust system.

More typically, plastic cages tend to hold the heat loads and malodorous environment accumulated in these cages over as briefly as one or two days. Odor and heat load control can require elaborate HVAC systems, lowering cage density of animal populations, increasing bedding change frequency, and necessary cleaning and/or disinfecting of every cage. These solutions are expensive and time consuming at the very least. Plastic cage disposal may also have an adverse environmental impact. U.S. Pat. No. 4,907,536 entitled Isolating Containers for Live Animals, the subject matter of which is incorporated herein by reference in its entirety to the fullest allowable extent, discloses cage air/gas filters constructed of cellulosic fiber mats, as well as a cage body made from the same material, which is said to resist water penetration but allow gaseous passage. Despite these attributes, rodents have a tendency to gnaw and chew through organic material, which could lead to cage destruction and animal escape, both of which have adverse environmental and economic consequences.

In view of the aforementioned and well recognized disadvantages of conventional cages/caging systems as well as the recognized, numerous challenges presented by the huge, global, laboratory, commercial, and pet small-animal populations, a need exists for containers and containment systems that successfully address the needs in this industry.

### SUMMARY OF THE INVENTION

An embodiment of the invention is directed to a biodegradable container for organic materials including, but not limited to, live small animals, biological materials, plants, and the like. In a non-exemplary and illustrative aspect, the container will be referred to hereinafter as a small-animal cage unit. In a more particular aspect, a small animal cage unit comprises a solid cage base having a floor and at least three sides extending upwardly therefrom and forming an open top area. The sides may be vertical or tilted from the vertical as long as the rear of the open top is higher than the front of the open top. The cage base is made from a non-petroleum-based material. An animal-resistant coating is bonded to the floor and at least a portion of the inside surfaces of the sides. A wire-mesh lid may be removably disposed in contact with at least a portion of the sides over the open top area. A cage base cover is removably disposed in contact with at least a portion of all the sides over the open top area. The cover includes a filtered air entry aperture in a front side thereof, a filtered air exit aperture in a rear side thereof, and a non-ventilated top surface. A front portion of the top surface has a viewing window. A gas-adsorbent material is coupled to an interior surface portion of the cover that is not windowed.

Another embodiment of the invention is directed to a containment rack system. The rack system comprises a vertically oriented, columnar support structure adapted to receive a plurality of cage unit support members; a plurality of cage unit support members removably disposable in the columnar support structure; and, a solid cage unit base (as described above) having a floor and at least three sides extending upwardly therefrom and forming an open top area. The cage unit base is made from a non-petroleum-based material. At least two opposing side walls each have a support shoulder extending therefrom, which are adapted to engage the cage unit support surfaces of the support members such that the mounted cage unit is disposed in a downwardly inclined direction from rear to front in the assembly at an angle, β, where 5≦β≦20 degrees with respect to horizontal. The cage unit includes an animal-resistant coating bonded to the floor and at least a portion of sides of the cage unit on inside surfaces thereof. A cage base cover is removably disposed in contact with at least a portion of all the side walls over the open top area, wherein the cover further comprises a filtered air entry aperture in a front side thereof, a filtered air exit aperture in a rear side thereof, and a non-ventilated top surface. A forward portion of the top surface has a viewing window. A gas-adsorbent material is coupled to an interior surface portion of the cover that is not windowed. A columnar plenum has an open side and an open top, wherein the open side is immediately adjacent the air exit aperture. The plenum may include an exhaust fan disposed either vertically or horizontally. The columnar support structure may be integrated into the edges of the plenum structure. The system may further include a canopy having a fan and an exhaust port, removably disposed over the open top of the plenum.

According to the embodiments of the invention, the cage unit is a molded-fiber manufacture that is environmentally disposable. The structure of the containment system prevents odors and heat loads generated by the cage unit occupancy and emanating therefrom from contaminating the area holding the containment rack system.

The disclosed environmentally-friendly containment system eliminates the need for frequent bedding changes and/or cleaning of the cage units as well as for high dilution-ventilation requirements. Preventing the dissipation of odors and heat loads from the occupied cage units removes the need to individually ventilate the cage units and the holding room altogether.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 show a cross section of a free-standing cage unit according to an embodiment of the invention;

FIG. 2 shows an exploded assembly view of a containment system according to an illustrative embodiment of the invention;

FIGS. 3A, 3B show in cross-section ends of a cage unit cover for a rectangular cover and a domed cover, respectively, according to exemplary aspects of the invention;

FIGS. 4A, 4B show cage unit bracket/cage unit shoulder configurations for angularly-inclined brackets and for horizontally-disposed brackets in the containment system, respectively, according to exemplary aspects of the invention;

FIGS. 5A, 5B show cross sections of a cage unit with a bottle and a feeder in phantom, respectively, according to exemplary aspects of the invention;

FIGS. 6A, 6B, 6C, 6D show top plan views of a single plenum, a single linear plenum system, a double-sided linear plenum system, and a carousel-type plenum system, respectively, according to exemplary aspects of the invention;

FIGS. 7A, 7B, 7C, 7D show a system canopy and exhaust port, respectively, for the systems illustrated in FIGS. 6A, 6B, 6C, 6D;

FIG. 8 shows a perspective view of a double stack of cage units with individual exhaust fans in each plenum, according to an exemplary aspect of the invention; and

FIG. 9 shows a perspective view of a double stack of cage units with a plenum hood and single exhaust fan, according to an exemplary aspect of the invention.

### DETAILED DESCRIPTION OF EMBODIMENTS OF THE INVENTION

Reference will now be made in detail to the present exemplary embodiments of the invention, examples of which are illustrated in the accompanying drawings. Wherever possible, the same reference numbers will be used throughout the drawings to refer to the same or like parts.

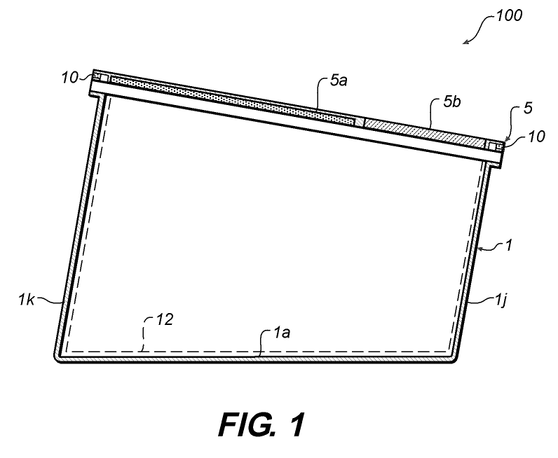

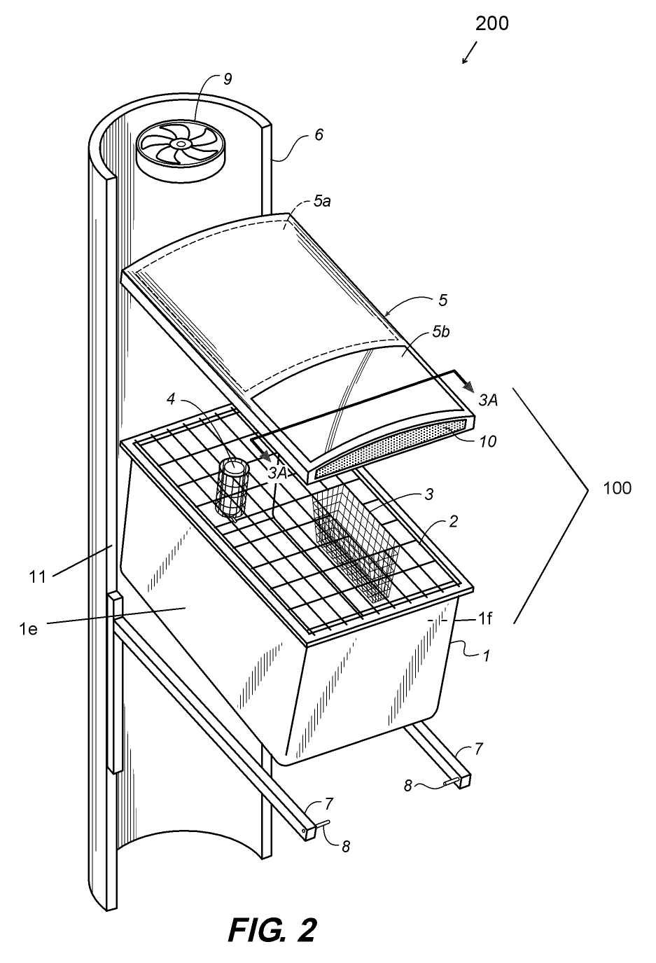

FIGS. 1 and 2 show a containment unit 100 (hereinafter, ‘cage unit’) according to an exemplary embodiment of the invention. The cage unit includes a solid base 1 having a floor 1a and at least two opposing solid sides (walls) 1e, 1f (FIG. 2) extending upwardly therefrom. At least one or two additional solid sides (e.g., 1j, 1k) may be present depending upon the shape of the cage. In a particular, non-limiting aspect, the cage as illustrated is rectangular. The cage base and walls provide an open top area. The cage base 1 is rendered environmentally friendly by constructing it from non-petroleum-based natural fibers such as wood pulp, paper, recycled paper, cardboard, or other cellulosic fibers. The cage base may be molded to finished shape from an aqueous slurry against an open-face suction mold and drying under pressure imposed by a mating pair of heated dies, for example. The non-petroleum-based molded fiber material can be pervious or permeable to moisture as well as respiration and waste gases emitted from animals or any oxidative processes occurring in the container.

An animal-resistant material 12 is bonded to the floor and at least to a portion of all the side walls on the inside surfaces thereof to prevent or discourage gnawing and/or scratching by a small animal occupant of the cage. The animal-resistant material may be in the form of a binder that forms a colloidal suspension with or without an abrasive material directly bonded by its own substance to the aforementioned cage surfaces. The binder may consist of synthetic or natural resins such as acrylics, polyurethanes, polyesters, melamine resins, epoxy, or oils. The abrasive material may include one or more of crushed ceramic, metal slivers, abrasive particles such as alumina, silica, sand stone, quartz, salts, diamond dust, iron pyrite flint, slate vermicalcite or other flaky rock particles, crushed glass, silicon carbide, abrasive bauxite, metallic shards, or combinations thereof. The coating can be bonded to the base via painting, spraying, and other known techniques. The abrasive material may be added to the primary binder bath or sprayed on, for example.

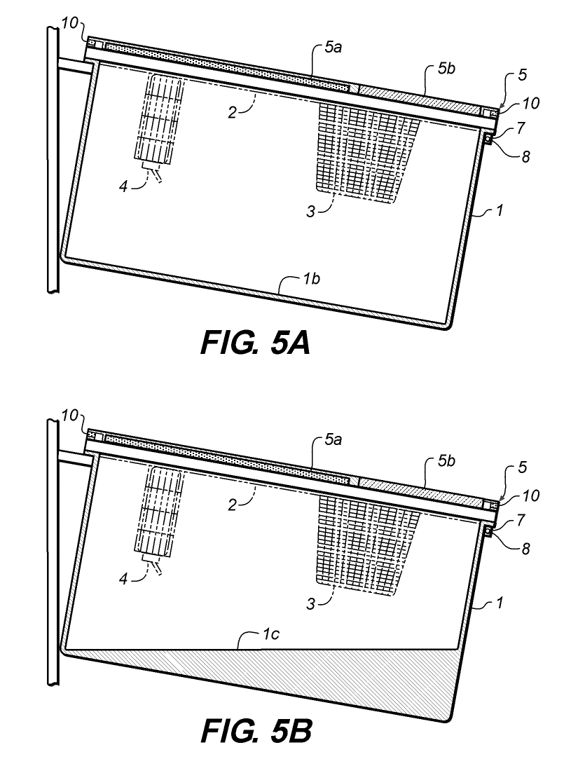

As shown in FIG. 1, the cage base 1 is constructed such that the open top is tilted downward from rear to front with respect to the horizontal. As shown, rear and front side walls 1k, 1j are both tilted with respect to vertical and are different heights. These side walls may be vertical and of different height to provide a higher rear open top region than the front open top region. The floor 1a is or may be (see 1c in FIG. 5A) made level for convenience. As discussed in greater detail below, and in conjunction with a cage base cover as described herein, a tilt of the open top will be between about 5 to 20 degrees with respect to horizontal and, nominally about 10 degrees, which assists in effectively drawing fresh room air into the front of the cover of the enclosed cage and exhaust air out the rear of the cover of the enclosed cage.

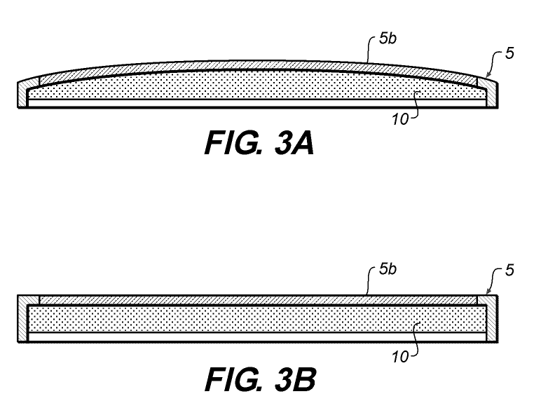

The cage unit 100 further comprises a cover 5 that can be held in place over the open cage base 1 by a secure press fit with the top perimeter of the cage walls. Other cover fitting mechanisms are well known in the art. The cover 5 may have a dome- or flat-shaped cross section as shown in FIGS. 3A, 3B, respectively. The front and back side-ends of the cover are fitted with an air filter material 10 and function as an air entry aperture and an air exit aperture, respectively. A nominal vertical dimension of the side-ends is between about 0.5 to 1.5 inches or more at an apex, up to about three inches. As further illustrated in FIG. 2, the cage cover 5 includes a viewing window 5b that in an exemplary aspect occupies approximately the front one-third of the top surface of the cover. Acetate would be a suitable biodegradable transparent window material as well as others known in the art. A non-limiting material for the cover would be molded fiber, a light-weight metal, or plastic. The inside surface of the rear approximately two-thirds of the cover is coated with, or covered with, an adsorbent material 5a (dotted line) such as, but not limited to, activated carbon.

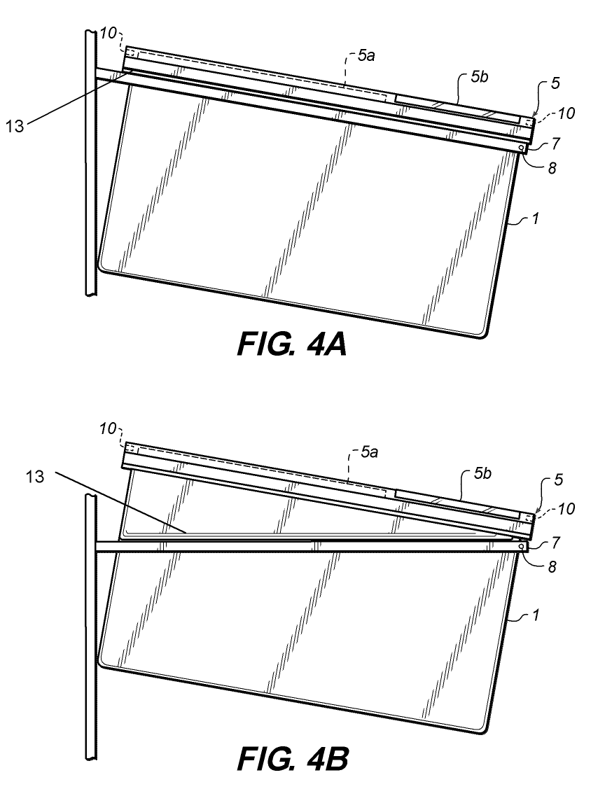

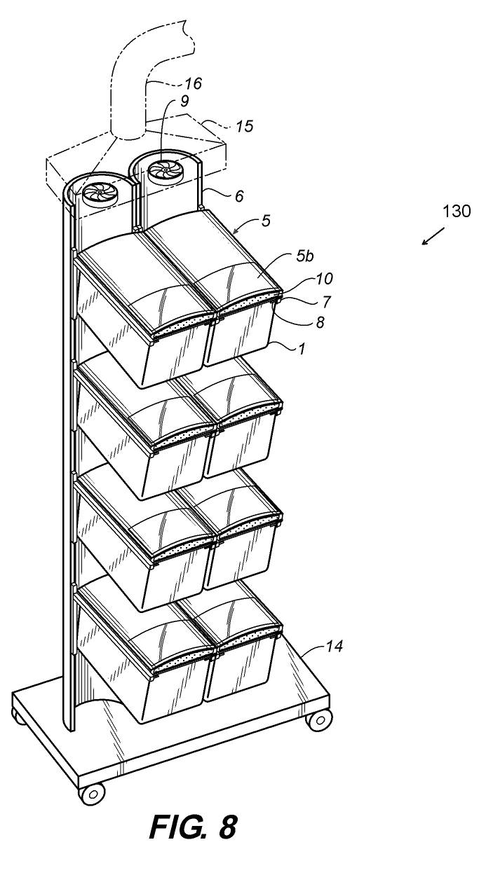

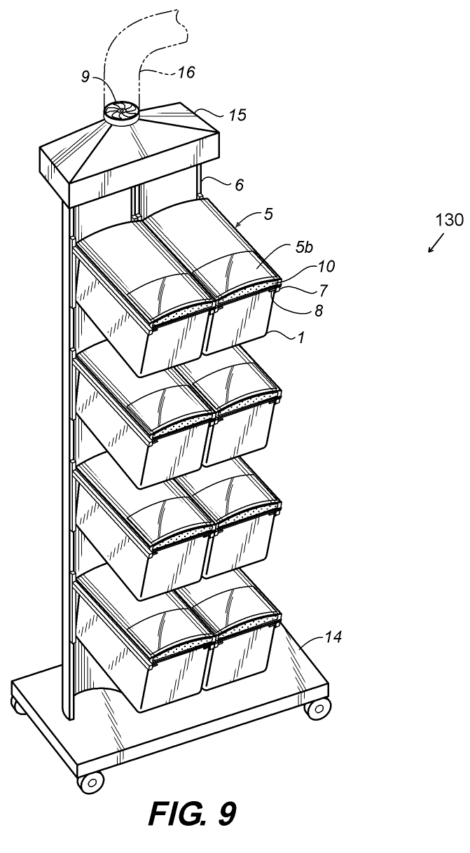

FIG. 2 shows a containment rack system 200, according to an exemplary embodiment. The system 200 includes a vertically oriented, columnar support structure 11 adapted to receive a plurality of containment unit (cage) support members 7. The cage support members 7 are adjustably and removably held in the columnar support structure 11. The cage unit 1 is as described above; however, as shown in FIGS. 4 and 5, the open top of the cage is not necessarily tilted with respect to the cage base bottom surface; rather, the cage tilt will be provided by the orientation of the cage base in the cage support members 7. In addition, the opposing side walls 1e, 1f each include a shoulder 13 that engages the support members 7 for mounting the cage in the system. As shown in FIG. 4A, the shoulder 13 is located around the top perimeter of the cage base. The arms of the support members 7 are tilted downward at an angle, β, of between about 5 to 20 degrees (nominally about 10 degrees) with respect to the vertical support member, so that the cage is supported at the desired angle to promote laminar air flow from cage front to rear through the filtered cover side-ends. Alternatively, as shown in FIG. 4B, the shoulders 13 are not at the wall perimeter but, rather, are themselves inclined at an appropriate angle, β, with respect to the cage proper (or the installed cover), in which case the arms of the support members can extend at 90 degrees from the vertical mounting sections. Tabs 8 at the distal ends of the arms of the support members may be used to securely locate the cage in the support members. The tabs may be fixed, spring-loaded, or otherwise activated. The system further includes a columnar plenum 6 having an open side area and an open top area, wherein the open side area is immediately adjacent the cover rear side-end, air exit aperture. The plenum may be constructed of a metallic or fiber material, for example. The inside surface of the plenum can be made reflective by covering or coating with a material such as aluminum or plastic to maximize convective heat transfer towards the top of the plenum. Although the plenum may be left open (uncovered), one or more passive or active exhaust fans 9 may be provided in the one or more plenums as illustrated in FIGS. 2 and 8. A canopy 15 may further be provided having an exhaust port 16, removably disposed over the open top area of the plenum. The canopy may be funnel-shaped or otherwise constricted to connect to the exhaust port 16. The canopy itself may be equipped with an exhaust fan 9 as illustrated in FIG. 9.

FIGS. 5A, 5B show additional exemplary features of the system A wire mesh lid 2 (see also FIG. 2) may be provided to fit over the open top of the cage base. The wire mesh lid can be configured to hold a water bottle 4 and feeder tray 3. A horizontally level floor 1c may be provided.

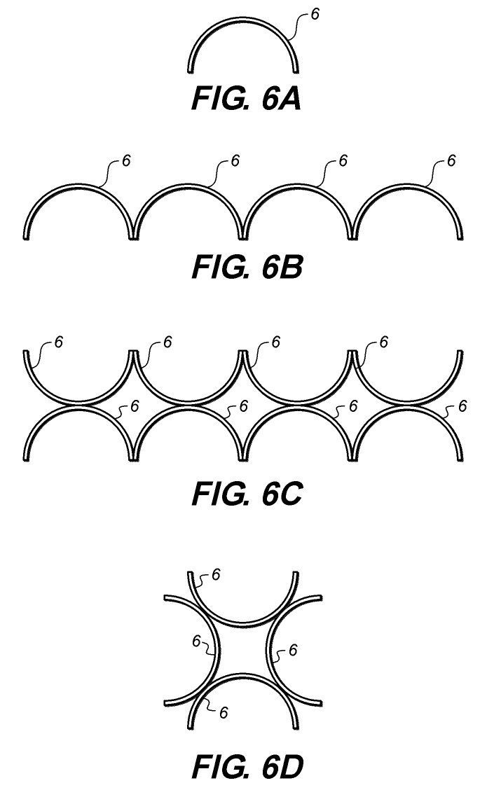

FIGS. 6A, 6B, 6C, 6D show alternative arrangements of the exhaust plenums 6 in top cross sectional views. FIG. 6A shows a single plenum; FIG. 6B shows a single-sided row of plenums; FIG. 6C shows a double-sided (back-to-back) arrangement of linear plenums; and, FIG. 6D shows a carousel-type plenum system.

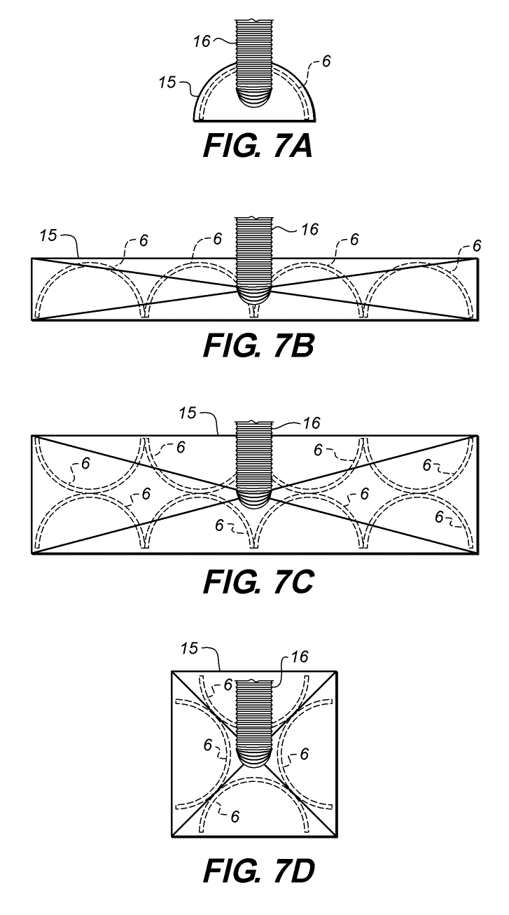

FIGS. 7A, 7B, 7C, 7D show a system canopy 15 and exhaust port 16 for the plenum systems illustrated in FIGS. 6A, 6B, 6C, 6D, respectively.

Each plenum 6 may incorporate an exhaust fan 9 as illustrated in FIG. 8. Alternatively, the canopy 15 may contain a single exhaust fan 9 as illustrated in FIG. 9. In all cases, an exhaust port 16 (e.g., exhaust hose) will provide a conduit for removing exhaust gases from the system.

FIGS. 8 and 9 each illustrate a single-sided, dual plenum, tilted rack system 130 with two columns of cages stacked side-by-side. The systems may be mounted on a movable base 14 for convenience.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

I claim:

1. A containment unit, comprising:
a solid containment unit base having a floor and at least three side walls extending upwardly therefrom and forming an open top, wherein a rear end of the open top is higher than a front end, further wherein the containment unit base is a non-petroleum-based material;
an animal-resistant coating bonded to the floor and to at least a portion of all of the side walls on inside surfaces thereof,
a cover removably disposed over the open top in contact with at least a portion of the side walls, wherein the cover comprises:
an air entry aperture;
an air exit aperture; and
a non-ventilated top surface, wherein a front portion of the top surface includes a viewing window;
an air filter media covering each of the air entry aperture and the air exit aperture; and
a gas-adsorbent material coupled to an interior surface portion of the cover that is not windowed.

2. The containment unit of claim 1, wherein the viewing window occupies about one-third of the top surface.

3. The containment unit of claim 1, wherein the rear-end of the open top is raised with respect to the front-end of the open top at an angle of between about 5 to 20 degrees with respect to horizontal.

4. A containment rack system, comprising:
a vertically oriented, columnar support structure adapted to receive a plurality of containment unit support members;
a plurality of containment unit support members adjustably, removably disposable in the columnar support structure, wherein the containment unit support members provide a containment unit support;
a solid containment unit base having a floor and at least three side walls extending upwardly therefrom and forming an open top, wherein the containment unit base is constructed of a non-petroleum-based material, further wherein at least two of the side walls each have a support shoulder extending therefrom that is adapted to engage the containment unit support surfaces of the support members, wherein the containment unit is disposed downwardly sloping from rear to front in the system at an angle of between about five to 20 degrees with respect to horizontal;
an animal-resistant coating bonded to the floor and at least a portion of all of the side walls on inside surfaces thereof;
a cover removably disposed over the open top in contact with at least a portion of the side walls, wherein the cover comprises:
an air entry aperture;
an air exit aperture; and
a non-ventilated top surface, wherein a forward portion of the top surface includes a viewing window;
an air filter media covering each of the air entry aperture and the air exit aperture;
a gas-adsorbent material coupled to an interior surface portion of the cover that is not windowed;
a columnar plenum having an open side and an open top, wherein the open side is immediately adjacent the air exit aperture; and
a canopy having an exhaust port, removably disposed over the open top of the plenum.

5. The containment rack system of claim 4, comprising a plurality of containment units disposed in at least one vertical stack in the assembly.

6. The containment rack system of claim 5, comprising a plurality of vertical stacks of containment units in the assembly.

7. The containment rack system of claim 6, comprising a respective plurality of plenums.

8. The containment rack system of claim 7, wherein the plurality of plenums form a single-sided linear arrangement and the vertical stacks of the containment units are oriented side-by-side.

9. The containment rack system of claim 7, wherein the plurality of plenums form a double-sided, back-to-back, linear arrangement and the vertical stacks of the containment units are oriented side-by-side.

10. The containment rack system of claim 7, wherein the plurality of plenums are disposed radially about a central vertical axis of the system.

11. The containment rack system of claim 4, wherein viewing window occupies about one-third of the top surface.

12. The containment rack system of claim 4, wherein the plurality of containment unit support members include support arms that are disposed at a downwardly inclined angle of between about five to 20 degrees with respect to horizontal.

13. The containment rack system of claim 12, wherein the cage unit support shoulders are disposed parallel to the cage unit cover.

14. The containment rack system of claim 4, wherein the plurality of containment unit support members include support arms that are disposed horizontally.

15. The containment rack system of claim 14, wherein the cage unit support shoulders are disposed at an angle to the cage unit cover.
